(19) United States
(12) Patent Application Publication
(10) Pub. No.: US 2016/0149837 A1
(43) Pub. Date: May 26, 2016

(54) SOCIAL NETWORK CHANNEL COMMUNICATION

(71) Applicant: Anto TOMS, Floral Park, NY (US)

(72) Inventor: ANTO TOMS, FLORAL PARK, NY (US)

(21) Appl. No.: 14/899,666

(22) PCT Filed: Jun. 19, 2014
(86) PCT No.: PCT/US14/43262

§ 371 Date: Dec. 18, 2015

Related U.S. Application Data
(60) Provisional application No. 61/836,871, filed on Jun. 19, 2013.

(51) Int. Cl. H04L 12/58; H04W 4/14; G06Q 50/00

(52) U.S. Cl. CPC H04L 51/04; G06Q 50/01; H04W 4/14; H04L 51/32

(57) ABSTRACT

Technologies are described for methods and systems effective for sending a communication from a first device to a second and a third device. The methods may comprise receiving a request to send the communication from the first device to a group that includes the second and the third device. The methods may include determining the group includes the second device and the third device. The methods may comprise identifying an email address associated with the second device. The methods may comprise identifying a text address associated with the third device. The methods may comprise sending the communication to the second device with use of the email address. The methods may comprise sending the communication to the third device with use of the text address.

### CROSS REFERENCE TO RELATED APPLICATIONS

This application claims priority to provisional application No. 61/836,871 filed Jun. 19, 2013, entitled “HIERARCHICAL GROUPING IN SOCIAL NETWORKS”, the entirety of the application is hereby incorporated by reference.

### BACKGROUND

Social networks include interaction through computer networks. Information may be exchanged between users within a computerized social network. A computerized social network may provide computer mediated communication for the exchange of information between users of the computerized social network.

### SUMMARY OF THE INVENTION

In some examples, methods for sending a communication from a first device to a second and a third device are generally described. The methods may comprise receiving a request to send the communication from the first device to a group that includes the second and the third device. The methods may include determining the group includes the second device and the third device. The methods may comprise identifying an email address associated with the second device. The methods may comprise identifying a text address associated with the third device. The methods may comprise sending the communication to the second device with use of the email address. The methods may comprise sending the communication to the third device with use of the text address.

In one example, apparatus effective to send a communication from a first device to a second device and a third device are generally described. The apparatus may comprise a memory with instructions. The apparatus may comprise a processor in communication with the memory. The processor may be effective to receive a request from the first device to send the communication to a group. The group may include the second and the third device. The processor may be effective to determine that the group includes the second device and the third device. The processor may be effective to identify an email address associated with the second device. The processor may be effective to identify a text address associated with the third device. The processor may be effective to send the communication to the second device with use of the email address. The processor may be effective to send the communication to the third device with use of the text address.

In one example, methods for providing communication with a group on a social network are generally described. The methods may comprise a processor receiving a first request to join the social network. The methods may comprise the processor processing the first request to generate a first member of the social network. The methods may comprise the processor receiving a second request from the first member of the social network. The second request may be to generate a first contact with a second member of the social network. The methods may comprise the processor processing the second request to generate the first contact. The methods may comprise the processor receiving a third request from the first member of the social network. The third request may be to make a second contact with a third member of the social network. The methods may comprise the processor processing the third request to generate the second contact. The methods may comprise the processor receiving a fourth request from the first member of the social network. The fourth request may be to group the first and second contacts into a group. The methods may comprise the processor processing the fourth request to group the first and second contacts into the group. The methods may comprise the processor receiving a fifth request. The fifth request may be to send a communication to the group. The methods may comprise the processor identifying an email address associated with the first contact. The methods may comprise the processor identifying a text address associated with the second contact. The methods may comprise the processor sending the communication to the first contact with use of the email address. The methods may comprise the processor sending the communication to the second contact with use of the text address.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and other features of this disclosure will become more fully apparent from the following description and appended claims taken in conjunction with the accompanying drawings. Understanding that these drawings depict only some embodiments in accordance with the disclosure and are therefore not to be considered limiting of its scope, the disclosure will be described with additional specificity and detail by reference to the accompanying drawings in which:

FIG. 1 illustrates an example system 100 that can be utilized to implement social network channel communication;

FIG. 2 illustrates an example system 100 that can be utilized to implement social network channel communication;

FIG. 3 illustrates a flow diagram of an example process for implementing social network channel communication;
all in accordance with an embodiment of the invention.

### DETAILED DESCRIPTION

In the following detailed description, reference is made to the accompanying drawings which form a part thereof. In the drawings, similar symbols typically identify similar components unless context indicates otherwise. The illustrative embodiments described in the detailed description, drawings and claims are not meant to be limiting. Other embodiments may be utilized and other changes may be made without departing from the spirit or scope of the subject matter presented herein. It will be readily understood that the aspects of the present disclosure as generally described herein and as illustrated in the accompanying figures can be arranged, substituted, combined, separated and/or designed in a wide variety of different configurations all of which are explicitly contemplated herein.

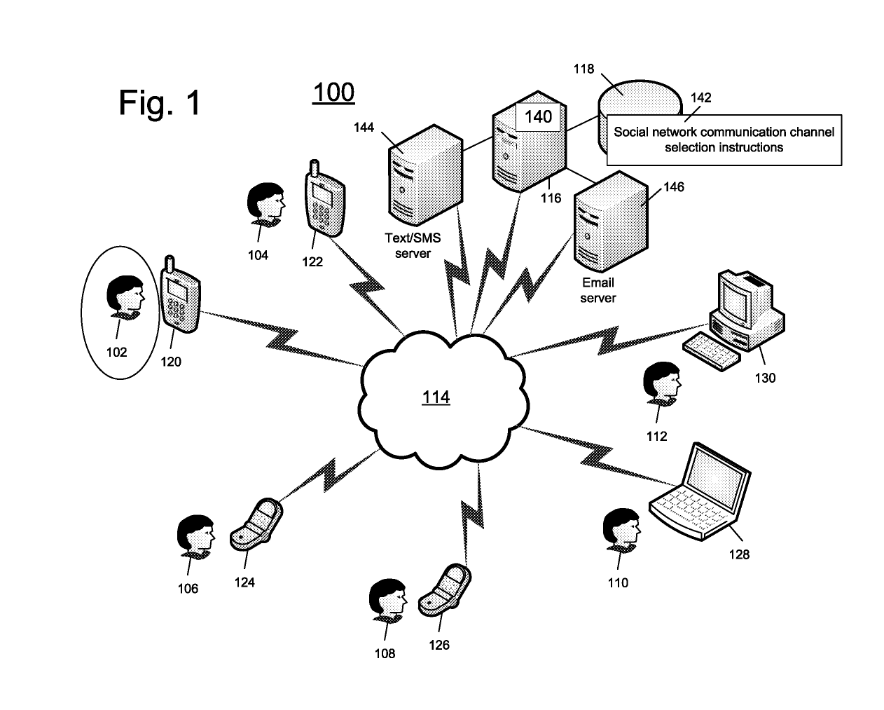

FIG. 1 illustrates an example system 100 that can be utilized to implement social network channel communication, arranged in accordance with at least some embodiments presented herein. System 100 may include a social network processor 116 and a memory 118. Processor 116 may be in communication with a text/short message service (SMS) server 144, an email (SMTP—simple mail transfer protocol) server 146, and memory 118. Memory 118 may include social network communication channel selection instructions 142. System 100 may be accessed by a user 102 using device 120, a user 104 using device 122, a user 106 using device 124, a user 108 using device 126, a user 110 using device 128 and/or a user 112 using device 130. Devices 120, 122, 124, 126, 128, and 130 may all be configured to communicate over network 114. Devices 120, 122, 124, 126, 128, and 130 may be a cell phone, a smart phone, a tablet device, a wearable device such as GOOGLE GLASS, a laptop computer, a desktop computer any other communication device. Communication may be by text message such as short message service (SMS), instant message (IM), email such as SMTP communication, or any other digital communication method. Network 114 may be a cellular network, a WIFI network, the Internet or any other network.

A user 102, using a device 120, may want to join a social network 140. User 102 may use device 120 to communicate with processor 116. User 102 may use device 120 to provide information to processor 116 to join social network 140. User 102 may provide an identification of user 102, and channels of communication, such as email or a mobile phone number, to processor 116 to join social network 140. User 102 may be required to provide processor 116 with at least one channel of communication. Data related to user 102, such as identification information, and channels of communication to be used to contact user 102, may be stored in memory 118. Memory 118 may include databases of data related to members of social network 140. Data in memory 118 may be encrypted to protect member information.

After user 102 joins social network 140, a membership status of user 102 may be stored in memory 118. User 102 may create contacts or groups in social network 140. User 102 may use device 120 to send a request. The request may be to generate a contact with another member of social network 140. Device 120 may send the request over network 114 to processor 116. User 102 may provide an email address or a phone number of the requested contact in the request. The request sent to processor 116 by user 102 may include an email address or a phone number of user 104 as well as information about user 102. For example, user 102 may send a request to make a contact with user 104. Processor 116 may send the request from user 102 over network 114 to device 122 and user 104. User 104 may accept or reject the request and may use device 122 to send the acceptance or rejection over network 114 to processor 116. Upon accepting the request, user 104 may determine one or more channels upon which communications with user 104 may be received from user 102. User 102, upon having the request accepted, may also determine one or more channels upon which communications with user 102 may be received from user 104. Processor 116 may process the request and generate the contact. Processor 116 may store information related to user 102 and user 104 in memory 118. Information stored in memory 118 may include member data related to communication methods for user 102 such as email or short message service (SMS), and may include an email address and/or phone number for user 102. Processor 116 may execute social network communication channel instructions 142 to determine communication channels between user 102 and user 104. As discussed in more detail below, processor 116 may utilize text/SMS server 144 and/or email server 146 to send messages to and/or between user 102 and 104.

Members of social network 140, such as user 102, may have contacts associated with social network 140 included in a contact list. A contact list for each user may be stored by processor 116 as data in memory 118. Data in memory 118 may be encrypted to protect member information. User 102 may, through device 120 communicating with processor 116, remove a contact from a contact list of user 102. When user 102 removes a contact from his/her contact list, no further communication may take place between the contact and user 102 unless a new contact request is initiated by user 102, or from the removed contact. For example, if user 102 removes user 104 from a contact list, user 104 may not communicate with user 102. Either user 102 or user 104 may initiate a contact request to the other user in order to re-establish a contact status and communicate with the other user.

User 102 may create groups of contacts. Groups of contacts created by user 102 may be grouped based on a membership status of the contacts. Groups of contacts created by user 102 may be processed by processor 116 and stored in memory 118. Data stored in memory 118 may be encrypted to protect group member information. Groups created by user 102 may include features of the group such as communication rules regarding messaging and notification of contacts within the group. For example, communication within a group may be performed by email, SMS or both. All contacts connected to user 102 may be included in a default contact group with a default set of communication rules. User 102 may be an owner of a group created by user 102. User 102 may have one or more administrators for a group owned by user 102. An administrator may be associated with user 102 and may be authorized by user 102 to approve and/or reject contacts within a group. An administrator may be restricted within a group and may not be authorized to create or delete a group. Data stored in memory 118 may also include contacts who are members of social medial network 140, and groups related to user 102. Groups related to user 102 may include groups owned by user 102 and groups of which user 102 is a member.

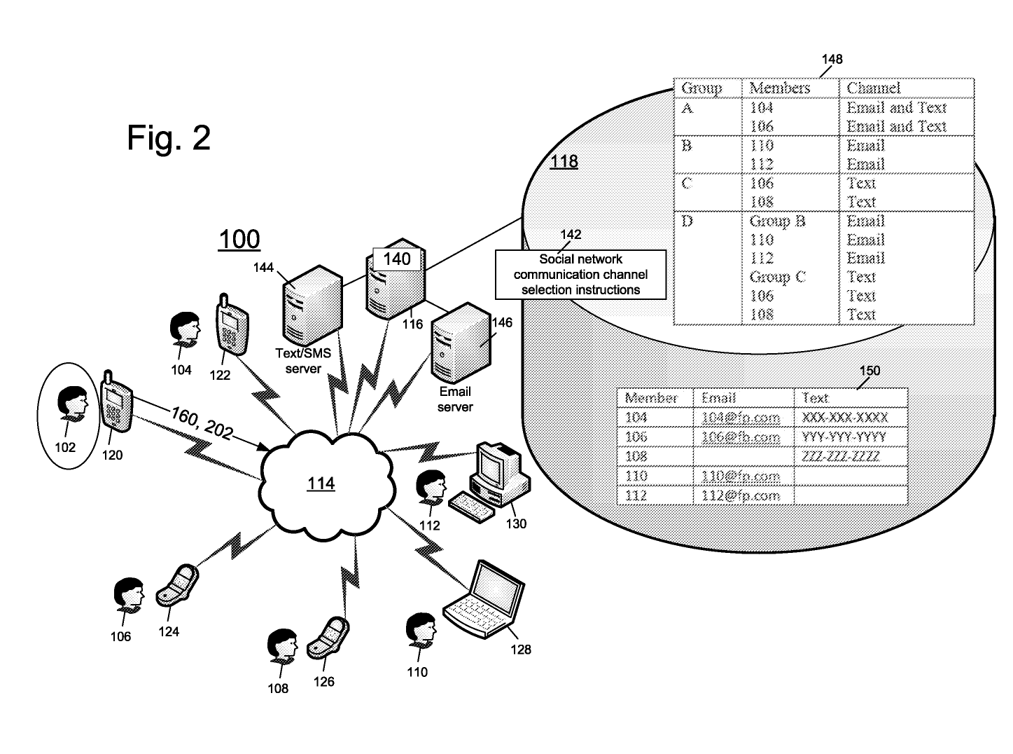

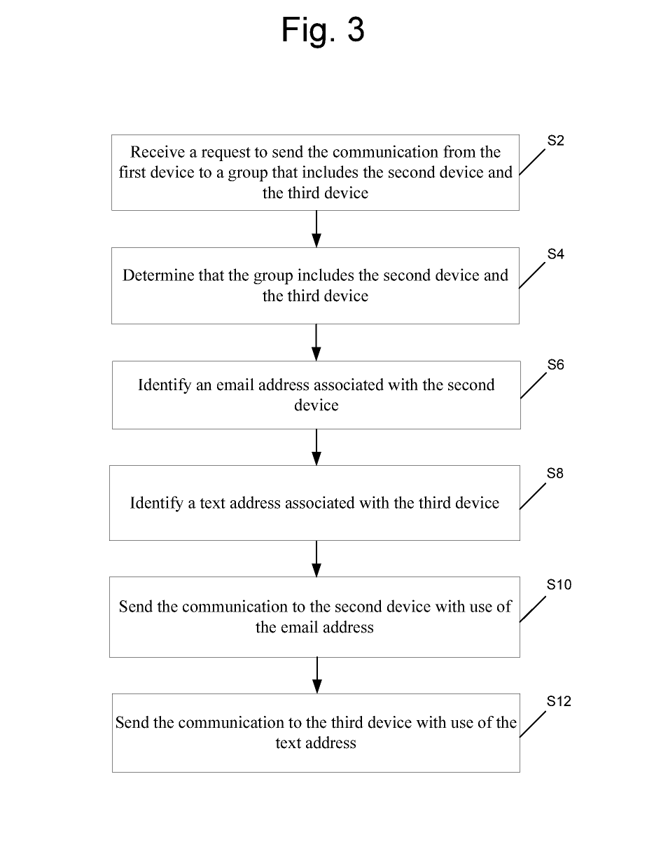

FIG. 2 illustrates an example system 100 that can be utilized to implement social network channel communication, arranged in accordance with at least some embodiments presented herein. System 200 depicted in FIG. 2 is substantially similar to system 100 of FIG. 1, with additional details. Those components in FIG. 2 that are labeled identically to components of FIG. 1 will not be described again for the purposes of clarity.

A user may create a group and communicate with members of the group using both SMS and email channels. In an example, user 102 may create a group A. User 102 may use device 120 to communicate with processor 116 to create a group A. Social network members 104 and 106 may be contacts with user 102. User 102 may send a group request 160 from device 120 to processor 116 requesting that contacts 104 and 106 join group A. Social network member 104 using device 122, and social network member 106 using device 124, may reply to processor 116 to accept the group request. Processor 116 may require each social network member (104 and 106) to provide a channel of communication, such as email or text, to be used for communications from group A to the social network member when joining group A. Processor 116 may store data related to groups as a table 148 in memory 118.

For example, social network member 106 may use device 124 to communicate with processor 116 and social network 140. Device 124 may be a cell phone and may not have email capabilities. Social network member 106 may provide processor 116 with a cell phone number and designate text as a channel of communication to be used for communications from group A to social network member 106. Processor 116 may not require each social network member (104 and 106) to provide a channel of communication to be used for communications from group A when a channel of communication is already provided, such as by data stored in a table 150 in memory 118 related to as information provided by each social network member upon joining social network 140. Upon acceptance of the requests to join group A by social network members 104 and 106, group A may include social network members 104 and 106. Data related to group A may be stored by processor 116 in memory 118 and may include group members (104 and 106) and channels of communication (email, text) associated with each member of group A. Social network members within group A may each have all the same channel of communication or different channels of communication. A channel of communication may be associated with a group when the group is created to only communicate through one channel of communication, or a channel of communication may be associated with each social network member in a group.

User 102 may use the above method to create a group B. Group B may include social network members 110 and 112. Data related to group B may be stored by processor 116 in memory 118 and may include social network members (110 and 112) and channels of communication (email) associated with each social network member of group B. Group B may only have email as a channel of communication when group B is created to only have email as a channel of communication or when all social network members in group B have only email as a channel of communication. User 102 may create a group C. Group C may include social network members 106 and 108. Data related to group C may be stored by processor 116 in memory 118 and may include group members (106 and 108) and channels of communication (text) associated with each social network member of group C. Group C may only have text as a channel of communication when group C is created to only have text as a channel of communication or when social network members 106 and 108 only have text as a channel of communication. User 102 may create a group D of groups B and C. Data related to group D may be stored by processor 116 in memory 118 and may include data from group B and data from group C.

User 102 may want to send a message 202 to members of group A. User 102 may send message 202 to processor 116 to send message 202 to members of group A. User 102 may send message 202 to processor 116 in a number of ways. For example, user 102 may send message 202 to processor 116 by email, text message, or may enter message 202 in a user interface on a browser generated by processor 116. Processor 116 may analyze memory 118, determine group A social network members data from memory 118, identify respective email and/or text addresses, and execute social network communication channel instructions 142 to select a communication channel to utilize to send message 202 to members of group A. Processor 116 may utilize text/SMS server 144 and/or email server 146 to send message 202 to members of group A. Processor 116 may utilize text/SMS server 144 to send message 202 as a text message to social network member 106 and processor 116 may utilized email server 146 to send message 202 as an email message to social network member 104.

User 102 may want to send a message 202 to members of group D. User 102 may send message 202 to processor 116 to send message 202 to members of group D. Processor 116 may access group D social network members data from memory 118. Group D data may include social network members data from group B and social network members data from group C. Processor 116 may execute social network communication channel instructions 142 to select communication channel to utilize to send message 202 to social network members of group B. Processor 116 may execute social network communication channel instructions 142 to select communication channel to utilize to send message 202 to social network members of group C. Processor 116 may utilize email server 146 to send message 202 as an email message to social network members of group B. Processor 116 may utilize text/SMS server 144 to send message 202 as text messages to social network members of group C.

User 102 may communicate with contacts of user 102 through an event. User 102 may create an event on social network 140 and may send communications about the event to user 102 contacts by both text and email.

Members of a group on social network 140 may communicate within the group by sending a message to processor 116. Processor 116 may display the message at a location which members of the group may have access to view such as a social network page. A group from one member of social network 140 may join a group from a second member of social network 140. A joined group may be a “parent group” and a group joining a group may be a “child group”. A token may be required by processor 116 by a first member as part of joining a first group (child group) owned by the first member of social network 140 with a second group (parent group) owned by a second member of social network 140. The token may be acquired out of band, or outside of the social network from the parent group administrator or owner.

When a child group joins a parent group the child group, the parent group may control the messaging and notifications of the contacts within the child group. A parent group may temporarily suspend and/or activate a child group. A parent group may have control over the child group such as to limit settings for messaging and/or modifying any notification of contacts within a child group.

When a child group joins a parent group, billing for communications may be retained by either the child group or the parent group. For example, a child group may join a parent group to obtain information from the parent group. The child group may be billed for all communications from the parent group in such a scenario. In another example, a parent group may want its communications to reach as many contacts as possible and may be billed for all communication to child groups in order to incentivize more child groups to join.

User 102, as a member of social network 140, may buy channel credits. Channel credits may be used by a member of social network 140 to communicate with a group of contacts, or an individual contact. Channel credits may be expressed as a number of SMS texts or emails and may be purchased by a member of social network 140.

A parent group may communicate, such as send notifications, to all groups that join the parent group. Parent groups that join other parent groups and may form an association hierarchy. For example, a national group may be a parent group to a regional group. The regional group may be a parent group to a city group. The city group may be a parent to a community group. In such a scenario, the national group may communicate with regional group contacts, city group contacts and community group contacts. The regional group may communicate with city group contacts and community group contacts. The city group may communicate with the community group contacts. The community group may communicate within the community group.

A user 102 that is a member of a parent group may send a notification to an administrator of a specific child group associated with the parent group. The number of child groups that may join a parent group may be limited by the subscription level of the parent group within social network 140. The subscription level of a parent or child group may also control the levels of a group within a group hierarchy.

A child group may initiate a withdrawal request to processor 116 to withdraw from a parent group. The withdrawal request may be part of the work flow through processor 116 and may be sent to the parent group by processor 116 for acceptance or rejection. A parent group may initiate a disassociation from a child group through processor 116. A parent group that initiated disassociation through processor 116 may not require the child group consent.

A user 108 may be a basic member of social network 140. User 108 as a basic member of social network 140 may initiate a group membership request from device 126 to processor 116 to join a group. If the group membership request is accepted, user 108 may be a member of the group. Once a member of the group, user 108 may receive notifications and messages. When a user of a device, such as user 108 and device 126 join a group, an agreed upon token may be required as part of the joining of the group. The token may be acquired by user 108 out of band from the group administrators or the group's owner. User 108, as a requirement to join a group, may be required to provide the email address of the owner or any one of the administrators. A membership request from a user may be sent to processor 116 and may be sent from processor 116 to the group owner and/or one or more administrators of the group for approval. An owner of a group may invite members to become administrators of the group by providing the members email identification.

Among other possible benefits, a system in accordance with the present disclosure may enable social network communication capabilities to users without smart phone or internet access. Communications from and to the social network may be both email and SMS and may connect and include cell phone users to a social network. The social network may reach more users and enhance communication by reaching users of both cell phones and the SMTP enabled devices.

FIG. 3 illustrates a flow diagram of an example process for implementing social network channel communication, arranged in accordance with at least some embodiments presented herein. The process in FIG. 3 could be implemented using, for example, system 100 discussed above and may be used for social network channel communication. An example process may include one or more operations, actions, or functions as illustrated by one or more of blocks S2, S4, S6, S8, S10 and/or S12. Although illustrated as discrete blocks, various blocks may be divided into additional blocks, combined into fewer blocks, or eliminated, depending on the desired implementation.

Processing may begin at block S2, “Receive a request to send the communication from the first device to a group that includes the second device and the third device.” At block S2, a processor may receive a request from a first device to send a communication to a group that includes the second and the third device. The first, second and third devices may be configured to communicate over network. The first second and third devices may be a cell phone, a smart phone, a tablet device, a wearable device such as GOOGLE GLASS, a laptop computer, a desktop computer any other communication device. The communication may be by text message such as short message service (SMS), instant message (IM), email such as SMTP communication, or any other digital communication method. The network may be a cellular network, a WIFI network, the Internet or any other network.

Processing may continue from block S2 to block S4, “Determine that the group includes the second device and the third device.” At block S4, the processor may determine that the group includes the second device and the third device. The processor may be in communication with a memory. The memory may include a database associated with the group. The processor may analyze the database to determine that the group includes the second device and the third device.

Processing may continue from block S4 to block S6, “Identify an email address associated with the second device.” At block S6, the processor may identify an email address associated with the second device. The processor may identify the email address associated with the second device by accessing data in a memory in communication with the processor.

Processing may continue from block S6 to block S8, “Identify a text address associated with the third device.” At block S8, the processor may identify a text address associated with the third device. The processor may identify the text address associated with the third device by accessing data in a memory in communication with the processor.

Processing may continue from block S8 to block S10, “Send the communication to the second device with use of the email address.” At block S10, the processor may send the communication to the second device with use of the email address. The processor may utilize an email server to send the communication as an email communication.

Processing may continue from block S10 to block S12, “Send the communication to the third device with use of the text address.” At block S12, the processor may send the communication to the third device with use of the text address. The processor may utilize a text/SMS server to send the communication as a text message.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method for sending a communication from a first device to a second device and a third device, the method comprising, by a processor:
receiving a request to send the communication from the first device to a group that includes the second device and the third device;
determining that the group includes the second device and the third device;
identifying an email address associated with the second device;
identifying a text address associated with the third device;
sending the communication to the second device with use of the email address; and
sending the communication to the third device with use of the text address.

2. The method of claim 1, wherein the method further comprises:
analyzing a memory based on the group of devices;
determining a first channel associated with fourth devices in the group, wherein the first channel includes respective email addresses associated with the fourth devices in the group;
determining a second channel associated with fifth devices in the group, wherein the second channel includes respective text addresses associated with the fifth devices in the group;
sending the communication to the fourth devices in the group with the use of the first channel and the respective email addresses; and
sending the communication to the fifth devices in the group with the use of the second channel and the respective text addresses.

3. The method of claim 2, wherein the group is a first group, and the method further comprises:
determining that the first group includes a second group of sixth and seventh devices;
determining the first channel associated with sixth devices in the second group, wherein the first channel includes respective email addresses associated with the sixth devices in the second group;
determining the second channel associated with seventh devices in the second group, wherein the second channel includes respective text addresses associated with the seventh devices in the second group;
sending the communication to the sixth devices in the second group with the use of the first channel and the respective email addresses; and
sending the communication to the seventh devices in the second group with the use of the second channel and the respective text addresses.

4. The method of claim 2, wherein the method further comprises:
receiving a second communication, wherein the second communication is received from a particular device in the group;
sending the second communication to the fourth devices in the group with use of the first channel and the respective email addresses; and
sending the second communication to the fifth devices in the group with use of the second channel and the respective text addresses.

5. The method of claim 2, wherein the method further comprises:
receiving a second communication, wherein the second communication is received from a particular device in the group; and
posting the second communication on a social network page.

6. The method of claim 1, wherein the request is received from the first device by email.

7. The method of claim 1, wherein the request is received from the first device by text.

8. An apparatus effective to send a communication from a first device to a second device and a third device, the apparatus comprising:
a memory with instructions; and
a processor in communication with the memory, the processor effective to:
receive a request from the first device to send the communication to a group that includes the second and the third device;
determine that the group includes the second device and the third device;
identify an email address associated with the second device;
identify a text address associated with the third device;
send the communication to the second device with use of the email address; and
send the communication to the third device with use of the text address.

9. The apparatus of claim 8, wherein the request is a request to send the communication to a group of devices, and the processor is further effective to:
analyze a database in the memory based on the group of devices;
determine a first channel associated with fourth devices in the group, wherein the first channel includes respective email addresses associated with the fourth devices in the group;
determine a second channel associated with fifth devices in the group, wherein the second channel includes respective text addresses associated with the fifth devices in the group;
send the communication to the fourth devices in the group with the use of the first channel and the respective email addresses; and
send the communication to the fifth devices in the group with the use of the second channel and the respective text addresses.

10. The device of claim 9, wherein the group is a first group and the processor is further effective to:
determine the first group includes a second group of sixth and seventh devices;
determine the first channel associated with sixth devices in the second group, wherein the first channel includes respective email addresses associated with the sixth devices in the second group;
determine the second channel associated with seventh devices in the second group, wherein the second channel includes respective text addresses associated with the seventh devices in the second group;
send the communication to the sixth devices in the second group with the use of the first channel and the respective email addresses; and
send the communication to the seventh devices in the second group with the use of the second channel and the respective text addresses.

11. The device of claim 9, wherein the processor is further effective to:
receive a second communication, wherein the second communication is received from a particular device in the group;
send the second communication to the fourth devices in the group with the use of the first channel and the respective email addresses; and
send the second communication to the fifth devices in the group with the use of the second channel and the perspective text addresses.

12. The device of claim 9, the processor further effective to:
receive a second communication, wherein the second communication is received from a particular device in the group; and
post the second communication on a social network page.

13. The device of claim 8, wherein the request is received from the first device by email.

14. The device of claim 8, wherein the request is received from the first device by text.

15. A method for providing communication with a group on a social network, the method comprising, by a processor:
receiving a first request to join the social network;
processing the first request to generate a first member of the social network;
receiving a second request from the first member of the social network to generate a first contact with a second member of the social network;
processing the second request to generate the first contact;
receiving a third request from the first member of the social network to make a second contact with a third member of the social network;
processing the third request to generate the second contact;
receiving a fourth request from the first member of the social network to group the first and second contacts into a group;
processing the fourth request to group the first and second contacts into the group;
receiving a fifth request to send a communication to the group;
identifying an email address associated with the first contact;
identifying a text address associated with the second contact;
sending the communication to the first contact with use of the email address; and
sending the communication to the second contact with use of the text address.

16. The method of claim 15, wherein the fifth request is a request to send the communication to a group of contacts, and the method further comprises:
analyzing a memory based on the group of contacts;
determining a first channel associated with third contacts in the group, wherein the first channel includes respective email addresses associated with the third contacts in the group;
determining a second channel associated with fourth contacts in the group, wherein the second channel includes respective text addresses associated with the fourth contacts in the group;
sending the communication to the third contacts in the group with the use of the first channel and the respective email addresses; and
sending the communication to the fourth contacts in the group with the use of the second channel and the respective text addresses.

17. The method of claim 16, wherein the group is first group method further comprises:
determining that a second group includes a third group of fifth and sixth contacts;
determining the first channel associated with fifth contacts in the third group, wherein the first channel includes respective email addresses associated with the fifth contacts in the third group;
determining the second channel associated with sixth contacts in the third group, wherein the second channel includes respective text addresses associated with the sixth contacts in the third group;
sending the communication to the fifth contacts in the third group with the use of the first channel and the respective email addresses; and
sending the communication to the sixth contacts in the third group with the use of the second channel and the respective text addresses.

18. The method of claim 16, wherein the method further comprises:
receiving a second communication, wherein the second communication is received from a particular contact in the group;
sending the second communication to third contacts in the group with the use of the first channel and respective email addresses; and
sending the second communication to the fourth contacts in the group with the use of the second channel and the respective text addresses.

19. The method of claim 16, wherein the method further comprises:
receiving a second communication, wherein the second communication is received from a particular contact in the second group; and
posting the second communication on a social network page.

20. The method of claim 15, wherein the fifth request is received by text.
